(19) United States
(12) Patent Application Publication
(10) Pub. No.: US 2015/0026749 A1
(43) Pub. Date: Jan. 22, 2015

(54) METHOD AND SYSTEM FOR MULTIMEDIA CONTENT DISTRIBUTION

(71) Applicants: Lionel Bringuier, Fatouville Grestain (FR); Tristan Leteurtre, Issy Les Moulineaux (FR)

(72) Inventors: Lionel Bringuier, Fatouville Grestain (FR); Tristan Leteurtre, Issy Les Moulineaux (FR)

(73) Assignee: ANEVIA, Gentilly (FR)

(21) Appl. No.: 14/378,359

(22) PCT Filed: Feb. 16, 2012
(86) PCT No.: PCT/IB2012/000542

§ 371 Date: Aug. 13, 2014

(51) Int. Cl. H04N 21/462; H04N 21/643; H04N 21/647; H04N 21/61

(52) U.S. Cl. CPC H04N 21/4621; H04N 21/6175; H04N 21/64322; H04N 21/64769
USPC 725/116

(57) ABSTRACT

The invention relates to a system for multimedia content distribution, the system comprising:
an Over The Top streaming server adapted to distribute multimedia contents over an unmanaged network with multiple available levels of quality;
a central monitoring unit adapted to receive technical metrics from probes at consumer's devices and to aggregate information relating to perceived quality of each of the distributed contents;
an agent adapted to receive the aggregated information and to act on the OTT server whenever a discrepancy is observed between the perceived quality of a given content and a predefined quality class assigned to said content, wherein the agent is adapted to act on the OTT server by modifying the availability of the levels of quality for a plurality of distributed contents.

### FIELD OF THE INVENTION

The invention relates to distribution of multimedia contents over unmanaged networks, and more specifically to over-the-top (OTT) streaming of video contents.

### BACKGROUND OF THE INVENTION

OTT distribution transmits streams using HTTP, the protocol which has been used for decades to transport web pages over the Internet. HTTP has already been used as a transport solution for video on demand (VoD) media embedded into web pages, especially on Adobe Flash-based sites, such as YouTube, Hulu and Dailymotion. However this solution does not stream in real-time, but instead relies on progressive downloading media files. The browser downloads the file from the HTTP web server and when it has a sufficient amount of data, starts to play the content while it continues to download the rest of the file. The main drawback to this approach is the length of time it takes to fill the initial buffer. Another issue associated with HTTP is streaming quality, which depends on the IP connection. Content streaming may be subject to stalling if there are fluctuations in bandwidth, leading to frame freezing. As a consequence, it is nearly impossible to use this solution to broadcast live channels.

Until recently, live broadcasting was therefore restricted to operator-managed IPTV networks using the UDP multicast protocol. IPTV is delivered over a dedicated, operator-managed network that is used only for broadcasting TV. The operator has full control over the network and can configure specific parameters, such as bandwidth consumption and jitter prevention to ensure a high level of service quality. Traditional IPTV uses TS (transport stream) transmission technology which is based on satellite TV broadcasting and delivers content over UDP in datagram mode.

The arrival of OTT streaming, however, has brought a new approach and it is now possible to achieve levels of streaming quality over HTTP that allow video content (live, VoD, catchup, etc.) to be broadcast over the Internet.

A white paper from applicant gives an overview of the different known OTT solutions:

htt.://www.anevia.com/IMG/pdf/Anevia_White-Paper_OTT-Streaming_{—}2nd_Edition

Whenever OTT streaming is used for video content distribution, the perceived service quality from end consumers is an essential factor for service providers, (telecommunication companies, multiple systems operators, broadcasters, content providers, etc . . . ) for the success of their service (long-term audience, churn, willingness-to-pay, etc . . . ). This perceived service quality depends notably on the video quality, which combines video screen size and frame rate.

As the content is streamed over unmanaged networks, its perceived service quality may be affected by several factors, such as consumer's device capacity, access network congestion, transport network congestion, quality of the encoder, original quality of the video, etc . . . The congestion of the network capacity is the most common source of problem. This congestion can in particular be affected by the overall bandwidth due to the quantity of contents being streamed simultaneously by a service provider.

Several mechanisms already exist to somehow manage the perceived service quality of a content distributed over unmanaged networks.

FIG. 1 is a scheme describing an “adaptive bitrates” mechanism. A service provider controls an OTT streaming server adapted to distribute multimedia contents over an unmanaged network 10. Each video program is encoded and distributed simultaneously with multiple levels of video quality. A manifest file is associated to each video program, which describes the various levels of quality available and provides pointers to fetch it.

An end consumer is equipped with a device (computer, TV, smart phone, etc . . . ) connected to the network 10. The consumer device may observe that it is unable to display a given video with a given quality and can chose through the manifest to fetch and display the same video program with a lower level of quality, until the level of quality may be increased.

This mechanism, which takes place exclusively at the consumer device end, is standard and supported by most of today's streaming formats and infrastructures. This mechanism is notably implemented in standards such as Apple HTTP Live Streaming, Microsoft Smooth Streaming, Adobe Flash Dynamic Streaming, MPEG-DASH.

FIG. 2 is a scheme describing a “probing & network fallback” mechanism. A service provider controls an OTT streaming server adapted to distribute multimedia contents over an unmanaged network 10. Each video program is encoded and distributed simultaneously with multiple levels of video quality. The service provider also controls a central monitoring unit and provides addresses of fallback networks 10′ in case of network congestion.

An end consumer is equipped with a device (computer, TV, smart phone, etc . . . ) connected to the network 10. A probe, i.e. a piece of software, is installed in the consumer device to monitor and report technical metrics of the perceived quality. The central monitoring unit configures the probes with the addresses of fallback networks 10′. When the probe observes a decrease of the perceived quality, it takes the decision to fallback to another distribution network if available. The probe reports the observed perceived quality to the central monitoring unit which aggregates the information and provides the service provider with overall quality information to allow configuration of the probes.

This mechanism relies on the development of a proprietary function within each device's software and is not widely implemented. This mechanism is notably implemented by Multi Content Delivery Network (CDN) aggregators such as Conviva® for isntance.

FIG. 3 is a scheme describing a “client-server video bandwidth adaptation” mechanism. A service provider controls a streaming server adapted to distribute multimedia contents over an unmanaged network 10. Each video program is encoded and distributed with a single level of video quality. An end consumer is equipped with a device (computer, TV, smart phone, etc . . . ) connected to the network 10. A probe, i.e. a piece of software, is installed in the consumer device to monitor technical metrics of the perceived quality. However, instead of reporting the observed metrics to a central monitoring unit as described in FIG. 2, the probe acting as a client instructs directly the streaming server to adapt the level of quality of the content streamed according to the bandwidth available. This mechanism is notably implemented in Real-Time Control Protocol (RTCP) and proprietary solutions such as PacketVideo or Vidiator.

None of the prior solutions described above is completely satisfactory.

The “adaptive bitrates” mechanism enables each consumer device to take action to adapt to the degradation of the perceived quality. However, this client-oriented decision algorithm does not allow any central control from the operator or content provider. Adaptive bitrates mechanisms results in random video quality degradation and uncontrolled behaviors of video quality switching. As a consequence, a congested network would force all connected devices to degrade the video quality.

The “probing & network fallback” mechanism requires the existence of a fallback network.

The “client-server video bandwidth adaptation” mechanism requires that the streaming server is serving only a single video quality. Today's standards have mostly departed from such proprietary systems, to the benefit of adaptive bitrates mechanisms serving multiple levels of video quality simultaneously for each of the distributed contents.

Furthermore, none of the above described mechanisms enables service providers to adjust the quality priority for each video program.

### SUMMARY OF THE INVENTION

The invention aims at prioritizing multimedia content quality.

The invention provides a mechanism that enables service providers to adjust the quality priority, either on-demand or dynamically, for each of the distributed contents according to its class of quality and/or to the ones of other distributed contents. The invention provides a centralized system to control and globally adjust quality of the distributed contents.

The service provider may assign to each of its distributed content (a live channel, an on-demand video, a catch-up program, etc . . . ) a given quality class according to an anticipated sensitivity of the consumer to its perceived quality. For example, a blockbuster movie in HD format may be assigned a higher quality class than a 5-years old low-format long-tail movie. A quality class can thus be assigned to each of the distributed contents either statically or dynamically. For example a subscription channel may be statically assigned a high quality class whereas a standard-definition talk-show channel with low-audience may be statically assigned a lower quality class; and a live HD sport channel may be dynamically assigned a higher quality class during the duration of a world-wide sport event broadcasted in exclusivity.

Service providers need a mechanism to prioritize continuously the contents they distribute for adjusting the level of perceived quality according to the assigned quality class. Such a mechanism is achieved with a method and system according to appended claims.

More specifically the invention relates to a system for multimedia content distribution, the system comprising:
an Over The Top streaming server adapted to distribute multimedia contents over an unmanaged network with multiple available levels of quality;
a central monitoring unit adapted to receive technical metrics from probes at consumer's devices and to aggregate information relating to perceived quality of each of the distributed contents;
an agent adapted to receive the aggregated information and to act on the OTT server whenever a discrepancy is observed between the perceived quality of a given content and a predefined quality class assigned to said content, wherein the agent is adapted to act on the OTT server by modifying the availability of the levels of quality for a plurality of distributed contents.

According to embodiments, the system of the invention may comprise one or more of the following characteristics:
the distributed multimedia contents are video programs;
the technical metrics received at the central monitoring unit include at least one of the frame rate and/or bandwidth of the content distributed at the consumer's device, the category of the consumer's device, the geographical location of the consumer's device;
the agent is adapted to act on the OTT server continuously while multimedia contents are being distributed;
the agent is adapted to act on the OTT server by suppressing at least one high quality level for at least one distributed content having a low quality class;
the agent is adapted to act on the OTT server by decreasing the bandwidth allocated to at least one distributed content having a low quality class and/or increasing the bandwidth allocated to at least one distributed content having a high quality class;
the agent is a service provider;
the agent is configured to automatically act on the OTT server based on predefined rules;
the agent is included into the central monitoring unit.

The invention also relates to a method for optimizing quality of service of multimedia contents distribution, the method comprising the steps of:
assigning a quality class to each distributed multimedia content;
distributing each multimedia content over an unmanaged network with multiple available levels of quality;
receiving technical metrics from probes at consumer's devices and aggregating information relating to perceived quality of each distributed content;
modifying the availability of the levels of quality for a plurality of distributed contents whenever a discrepancy is observed between the perceived quality of a given content and the quality class assigned to said content.

According to embodiments, the method of the invention may comprise one or more of the following characteristics:
the quality class is assigned to a given content statically;
the quality class is assigned to a given content dynamically;
the quality class is assigned to a given content by a service provider;
the step of modifying the availability of the levels of quality for a plurality of distributed contents comprises suppressing at least one high quality level for at least one distributed content having a low quality class;
the step of modifying the availability of the levels of quality for a plurality of distributed contents comprises decreasing the bandwidth allocated to at least one distributed content having a low quality class and/or increasing the bandwidth allocated to at least one distributed content having a high quality class;
the step of modifying the availability of the levels of quality for a plurality of distributed contents is performed on demand;
the step of modifying the availability of the levels of quality for a plurality of distributed contents is performed automatically based one predefined rules;
the step of modifying the availability of the levels of quality for a plurality of distributed contents is further performed based on the technical metrics;
the step of modifying the availability of the levels of quality for a plurality of distributed contents is performed continuously when multimedia contents is being distributed.

The invention further relates to a computer program product comprising one or more stored sequence of instruction that is accessible to a processor and which, when executed by the processor, causes the processor to carry out the steps of the method of the invention; and to a computer readable medium carrying out one or more sequences of instructions of such computer program product.

The method and system of the invention can be implemented over any adaptive bitrates mechanism in order to further improve the level of perceived quality for priority contents.

Further features and advantages of the invention will appear from the following description of embodiments of the invention, given as non-limiting examples, with reference to the accompanying drawings listed hereunder.

### BRIEF DESCRIPTION OF THE DRAWINGS

FIG. 1, already described, shows a scheme of a system for multimedia content distribution according to a first example of the prior art;

FIG. 2, already described, shows a scheme of a system for multimedia content distribution according to a second example of to the prior art;

FIG. 3, already described, shows a scheme of a system for multimedia content distribution according to a third example of the prior art;

FIG. 4 shows a scheme of a system for multimedia content distribution according to an embodiment of the invention;

FIG. 5A illustrates a quality distribution chart provided by a system according to the invention;

FIG. 5B illustrates an example of the impact of the method of the invention over the quality of distribution of one given content with low priority;

FIG. 5C illustrates another example of the impact of the method of the invention over the quality of distribution of one given content with high priority;

FIGS. 6A and 6B illustrate an example of the global impact of the method of the invention over the quality of distribution of a plurality of contents.

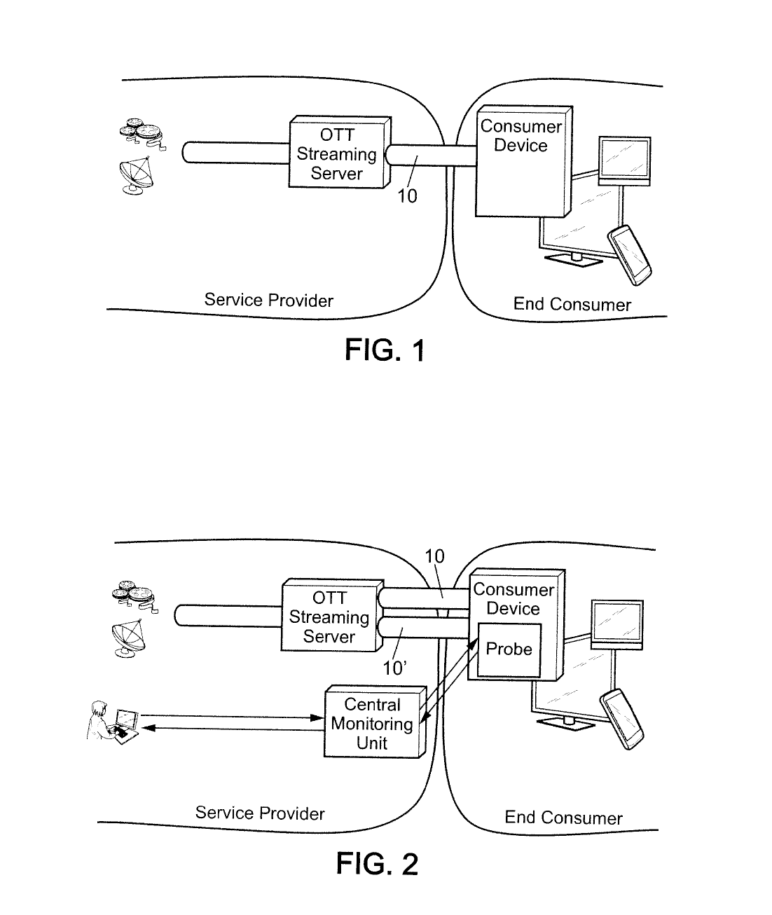

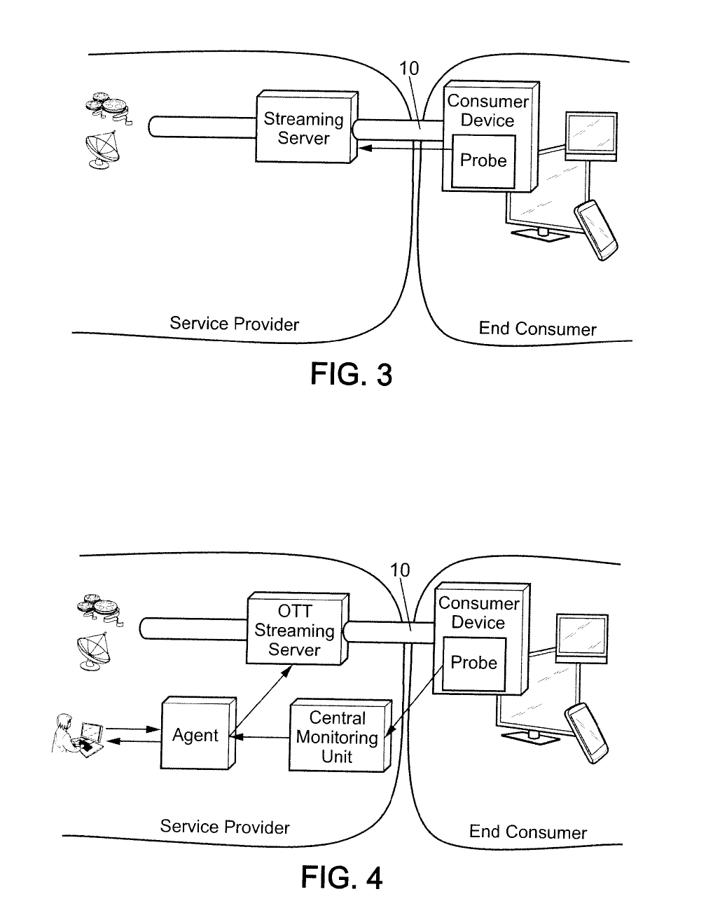

It can be appreciated that elements in the figures are illustrated for simplicity and clarity and have not necessarily been drawn to scale; they are solely provided to help improve the understanding of the embodiments of the present invention.

### DETAILED DESCRIPTION OF PREFERRED EMBODIMENTS

FIG. 4 illustrates a system according to an embodiment of the invention.

A service provider controls an OTT streaming server adapted to distribute multimedia contents over an unmanaged network 10, typically an IP network. The multimedia contents are video programs for instance. Each video program is encoded and distributed simultaneously with multiple levels of video quality. A manifest file is associated to each video program, which describes the various levels of quality available and provides pointers to fetch it.

An end consumer is equipped with a device (computer, TV, smart phone, etc . . . ) connected to the network 10. A probe, i.e. a piece of software, is installed in the consumer device to monitor and report technical metrics of the perceived quality.

The service provider also controls a central monitoring unit configured to receive the technical metrics from the probes at the consumer's devices and to aggregate information relating to perceived quality of each of the distributed contents.

The service provider further controls an agent adapted to receive the aggregated information from the central monitoring unit and to act on the OTT server. The agent, i.e. a piece of software, can be included into the central monitoring unit acting automatically on the OTT server based on predefined rules dictated by the service provider. Alternatively, the agent can be the service provider itself acting on demand on the OTT server.

The service provider assigns a quality class to each of its distributed multimedia content. Such a quality class is defined for each video program and defines a distribution priority for said program. The service provider assigns a quality class to each of its program based on its potential sensitivity to the congestion of the network used for distributing it which affects potentially its perceived quality.

The agent acts on the OTT server whenever a discrepancy is observed between the perceived quality of a given content—reported by the probes—and a predefined quality class assigned to said content. More specifically, the agent is adapted to act on the OTT server by modifying the availability of the levels of quality for a plurality of distributed contents. The action of the agent on the OTT server could be to increase or decrease the bandwidth allocated to the distribution of the video program for which a discrepancy is observed and/or to increase or decrease the bandwidth allocated to the distribution of other video programs distributed simultaneously over the unmanaged network.

For instance, the agent may instruct the OTT server to suppress at least one high quality level from the manifest file associated to at least one video program having a low quality class in order to keep high quality levels available for video programs having a higher quality class. The agent may also instruct the OTT server to decrease the bandwidth allocated to at least one video program having a low quality class and/or to increase the bandwidth allocated to at least one video program having a high quality class. Such action of the agent on the OTT server modifies the distribution priority of the video programs distributed simultaneously over the unmanaged network.

The distribution priority may be modified by action of the agent on the OTT server, either on demand from the service provider, specifically for a given program and/or a given period of time or automatically based on predefined rules set by the service provider. It is understood that even of an automated action of the agent on the OTT server is chosen, the service provider may intervene on the agent to further modify the distribution priority on demand.

The agent acts on the OTT server continuously to modify the distribution priority whenever necessary while multimedia contents are being distributed over the unmanaged network by the service provider.

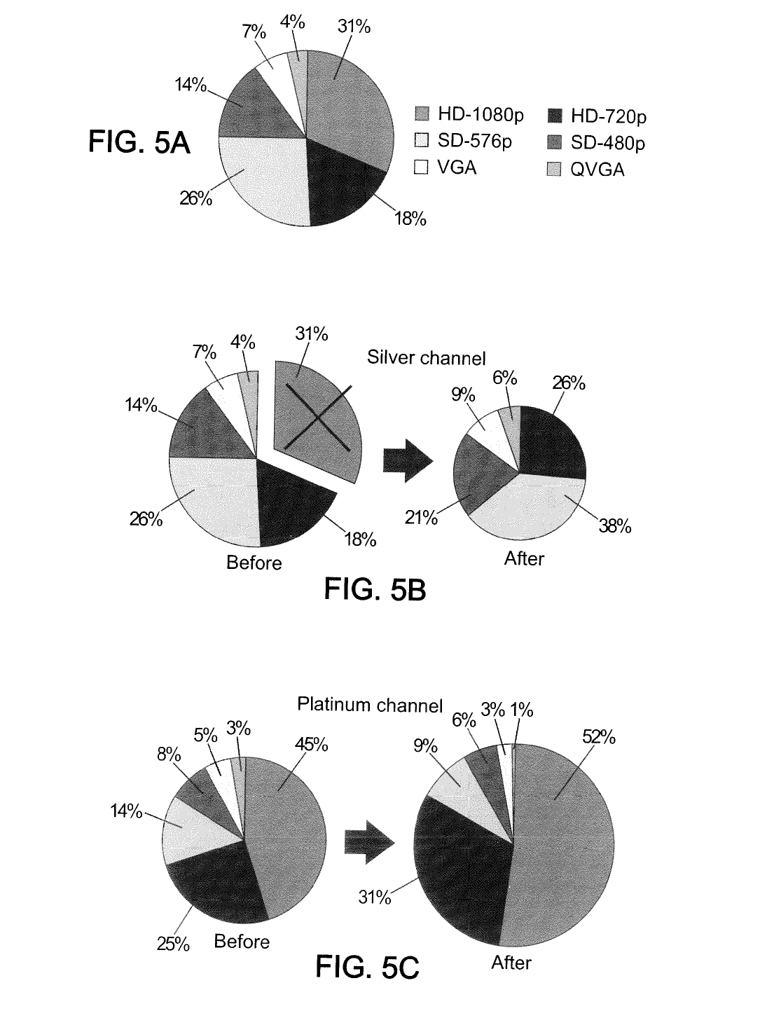

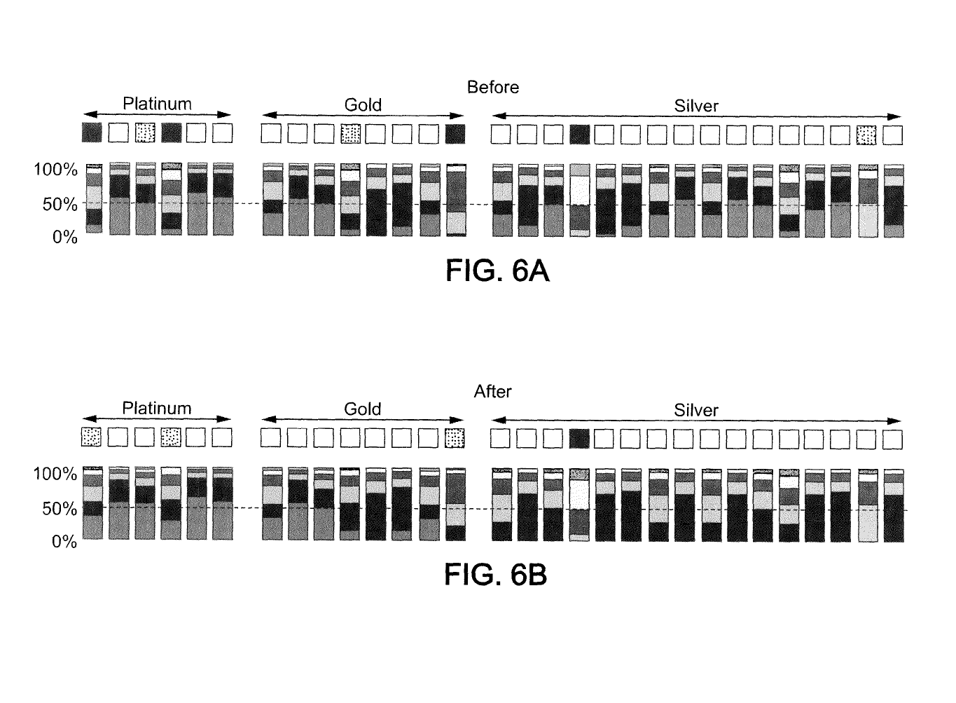

FIGS. 5 and 6 exemplify an embodiment for prioritizing multimedia content quality according to the invention.

For instance, three classes may be defined consisting of:
Platinum class where high quality levels should be favoured, for instance for subscription channels or HD VoD;
Gold class where high or medium quality levels should tried to be maintained, for instance national channels or SD VoD;
Silver class with no priority.

And six levels of quality may be defined consisting of:
HD-1080p optimized for Full HD TV;
HD-720p optimized for HD-ready TV;
SD-576p optimized for standard TV;
SD-480p optimized for tablets;
VGA optimized for smart phones;
QVGA optimized for feature phones.

Of course, a service provider may define less or more than three classes and more or less than six levels of quality included in the manifest file of each video program. The names of the classes can be different from the ones given above and the quality levels can be different from the ones cited above. The classes may apply to any program of a channel having an assigned class or different classes can be assigned to different programs broadcasted by a given channel by the service provider.

The classes may be assigned statically, the service provider setting a class to a given video program without the need to review the classification of said program. Subscription channels, sport channels and HD VoD for instance can be statically assigned a high quality class whereas news channels and SD VoD for instance can be statically assigned a lower quality class.

The classes may be assigned dynamically, the service provider setting a class to a video program for a given period of time, for instance for the duration of an event broadcasted exclusively over one channel or depending on hourly programming.

The OTT streaming server distributes a plurality of video contents with a plurality of quality levels simultaneously in formats adapted to the consumers' devices. The probes within consumers' devices observe the perceived quality of the displayed contents and report to the central monitoring unit. For instance, the technical metrics provided by the probe may include the category—TV, computer or smart phone and screen size for instance—of the consumer's device, frame rate and/or bandwidth at the consumer's device and localization of the consumer's device. The probe reports a perceived quality to the central monitoring unit deduced from said technical metrics. The central monitoring unit aggregates continuously the information provided by the probes and provides the agent with an instantaneous quality distribution chart as illustrated in FIG. 5A. Such a chart represents the distribution of quality levels for all consumers receiving a given content.

The agent offers to the service provider a continuous display of the instantaneous quality distribution charts of each distributed contents to allow actions to be taken over the OTT streaming server according to the quality class assigned to each of the contents. Notably alarms can be raised whenever a discrepancy is observed between the perceived quality of a given content and a predefined quality class assigned to said content.

Referring to the quality distribution chart of FIG. 5A, if such a chart corresponds to a platinum quality class content, it is observed that less than 50% of the consumers receive the content in HD quality, which is too little; and if such a chart corresponds to a silver quality class, it is observed that almost 50% of the consumers receive the content in HD quality, which is too much.

The agent may therefore instruct the OTT streaming server to perform actions in order to provide the content with its assigned quality class to a majority of consumers. The action on the OTT streaming server may be a suppression of at least one high quality level when the content is assigned a low quality class, as illustrated in FIG. 5B where the highest quality level (HD-1080p) defined above is completely disabled from the manifest file associated to the content. The result of such action on a low quality class content is to create more bandwidth for higher quality class contents for which high quality levels must remain available. If this action is not sufficient, further high quality levels (HD-720p or SD) could be disabled from the manifest file associated to a silver class content as defined above. The action on the OTT streaming server may also be to decrease the bandwidth required for a low quality class content and to increase the bandwidth required for a high quality class content, resulting in quality distribution charts as illustrated in FIGS. 5B-5C.

The action on the OTT server may be triggered on demand by the service provider analyzing the quality distribution charts or may be triggered automatically based on predefined rules set by the service provider.

The action on the OTT server may also depend on the technical metrics. For instance, if the technical metrics include information relating to the geographical location of the end consumer's devices, the action on the OTT server may be different for a content distributed to one location from the action for the same content distributed to another location. This can be implemented for instance during sport events involving specific towns. Furthermore, if the technical metrics include information relating to the category of the end consumer's devices, the action on the OTT server may be different for a content distributed to one category of device (HDTV for instance) from the action for the same content distributed to another category of device (smart phone for instance).

The action on the OTT streaming server whenever a discrepancy is observed between the perceived quality of a given content and the predefined quality class assigned to said content has a global impact on the various contents distributed simultaneously over the unmanaged network, as illustrated in FIGS. 6A-6B. FIG. 6A shows that several “Platinum” channels and “Gold” channels are distributed with lower quality levels than what would be expected from the consumers (dark and dotted squares) whereas some “Silver” channels are distributed with higher quality levels than needed (dark and dotted squares). The agent therefore acts on the OTT server, as shown on FIG. 6B, to modify the availability of the higher levels of quality of several “Silver” and “Gold” channels to allow more available bandwidth for “Platinum” channels to be distributed with the highest levels of quality.

For example, a video program with high assigned quality class could be distributed with six quality levels ranging from QVGA to HD1080p as defined above, while a video program with low assigned quality class could be distributed with only four quality levels ranging from QVGA to EDTV576p. Such action on the OTT server allows for the high quality class video program to be displayed in full HD quality, while the low quality class video program can be displayed only in SD quality, in order to decrease the network load.

It is understood that the values in percentage given in FIGS. 5A-5C or FIGS. 6A-6B are purely illustrative and not limiting.

The system and method of the invention allows action on a potential source of network congestion, while prioritizing each of the distributed contents according to its assigned quality class. Furthermore, the system and method of the invention remain completely compatible with existing standard adaptive bitrates mechanism, improving their performances by acting on the availability of the quality levels of each of the distributed contents.

The description was made with reference to some examples in order to facilitate understanding of the invention. It is however not limited to the exemplified illustrations, notably regarding the number of quality classes, quality levels and technical metrics.

1. A system for multimedia content distribution, the system comprising:
an Over The Top (OTT) streaming server adapted to distribute multimedia contents over an unmanaged network with multiple available levels of quality;
a central monitoring unit adapted to receive technical metrics from probes at consumer's devices and to aggregate information relating to perceived quality of each of the distributed contents;
an agent adapted to receive the aggregated information and to act on the OTT server whenever a discrepancy is observed between the perceived quality of a given content and a predefined quality class assigned to said content, wherein the agent is adapted to act on the OTT server by modifying the availability of the levels of quality for a plurality of distributed contents.

2. The system according to claim 1, wherein the distributed multimedia contents are video programs.

3. The system according to claim 1, wherein the technical metrics received at the central monitoring unit include at least one of the frame rate and/or bandwidth of the content distributed at the consumer's device, the category of the consumer's device, the geographical location of the consumer's device.

4. The system according to claim 1, wherein the agent is adapted to act on the OTT server continuously while multimedia contents are being distributed.

5. The system according to claim 1, wherein the agent is adapted to act on the OTT server by suppressing at least one high quality level for at least one distributed content having a low quality class.

6. The system according to claim 1, wherein the agent is adapted to act on the OTT server by decreasing the bandwidth allocated to at least one distributed content having a low quality class and/or increasing the bandwidth allocated to at least one distributed content having a high quality class.

7. The system according to claim 1, wherein the agent is a service provider.

8. The system according to claim 1, wherein the agent is configured to automatically act on the OTT server based on predefined rules.

9. The system according to claim 8, wherein the agent is included into the central monitoring unit.

10. A method for optimizing quality of service of multimedia contents distribution, the method comprising the steps of:
assigning a quality class to each distributed multimedia content;
distributing each multimedia content over an unmanaged network with multiple available levels of quality;
receiving technical metrics from probes at consumer's devices and aggregating information relating to perceived quality of each distributed content;
modifying the availability of the levels of quality for a plurality of distributed contents whenever a discrepancy is observed between the perceived quality of a given content and the quality class assigned to said content.

11. The method according to claim 10, wherein the quality class is assigned to a given content statically.

12. The method according to claim 10, wherein the quality class is assigned to a given content dynamically.

13. The method according to claim 10 wherein the quality class is assigned to a given content by a service provider.

14. The method according to claim 10, wherein the step of modifying the availability of the levels of quality for a plurality of distributed contents comprises suppressing at least one high quality level for at least one distributed content having a low quality class.

15. The method according to claim 10, wherein the step of modifying the availability of the levels of quality for a plurality of distributed contents comprises decreasing the bandwidth allocated to at least one distributed content having a low quality class and/or increasing the bandwidth allocated to at least one distributed content having a high quality class.

16. The method according to claim 10, wherein the step of modifying the availability of the levels of quality for a plurality of distributed contents is performed on demand.

17. The method according to claim 10, wherein the step of modifying the availability of the levels of quality for a plurality of distributed contents is performed automatically based on predefined rules.

18. The method according to claim 16, any one of claim 16 or 17, wherein the step of modifying the availability of the levels of quality for a plurality of distributed contents is further performed based on the technical metrics.

19. The method according to claim 10, wherein the step of modifying the availability of the levels of quality for a plurality of distributed contents is performed continuously when multimedia contents is being distributed.

20. (canceled)

21. (canceled)

22. A non-transitory computer-readable storage medium comprising a computer program comprising one or more stored sequence of instructions, that is accessible to a processor, for executing the steps of the method according to claim 10 when said computer program is executed by said processor.
